(19) United States
(12) Patent Application Publication
(10) Pub. No.: US 2026/0058263 A1
(43) Pub. Date: Feb. 26, 2026

(54) Secondary Battery and Method of Manufacturing the Same

(71) Applicant: Samsung SDI Co., Ltd., Yongin-si (KR)

(72) Inventor: Jea Woan LEE, Yongin-si (KR)

(73) Assignee: Samsung SDI Co., Ltd., Yongin-si (KR)

(21) Appl. No.: 18/913,499

(22) Filed: Oct. 11, 2024

(30) Foreign Application Priority Data
Mar. 21, 2024 (KR) 10-2024-0038887

(51) Int. Cl. H01M 50/15; H01M 10/0585; H01M 50/103; H01M 50/169; H01M 50/249; H01M 50/533; H01M 50/55; H01M 50/553; H01M 50/588

(52) U.S. Cl. CPC H01M 50/15; H01M 10/0585; H01M 50/103; H01M 50/169; H01M 50/533; H01M 50/55; H01M 50/553; H01M 50/588; H01M 50/249

(57) ABSTRACT

Disclosed is a secondary battery including an electrode assembly, a case accommodating the electrode assembly and including an open surface, a plate-shaped cover coupled to the open surface of the case and including a bent portion protruding toward the interior of the case, a first terminal disposed on second surface of the case and electrically connected to the electrode assembly, a second terminal disposed so as to be spaced apart from the first terminal and electrically connected to the electrode assembly, and an insulating member insulating the first terminal and the case from each other. The cover is pressed in a state of being placed on the open surface of the case to be coupled to the case. Because the coupling structure between the case and the cover is improved, the size of a dead space is minimized, and thus the capacity of the secondary battery is increased.

### CROSS-REFERENCE TO RELATED APPLICATIONS

This present application claims priority to and the benefit under 35 U.S.C. § 119(a)-(d) of Korean Patent Application No. 10-2024-0038887, filed on Mar. 21, 2024, in the Korean Intellectual Property Office, the entire disclosure of which is incorporated herein by reference.

### FIELD

The present disclosure relates to a secondary battery and a method of manufacturing the same.

### BACKGROUND

Unlike primary batteries that are not designed to be (re)charged, secondary (or rechargeable) batteries are batteries that are designed to be discharged and recharged. Low-capacity secondary batteries are used in portable small electronic devices, such as smart phones, feature phones, notebook(laptop) computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not constitute related (or the prior) art.

### SUMMARY

The present disclosure provides a secondary battery capable of improving a coupling structure between a case and a cover and a method of manufacturing the same.

These and other aspects and features of the present disclosure will be described in or will be apparent from the following description of embodiments of the present disclosure.

A secondary battery according to an embodiment of the present disclosure includes an electrode assembly, a case accommodating the electrode assembly and including an open surface, a plate-shaped cover coupled to the open surface of the case and including a bent portion protruding toward the interior of the case, a first terminal disposed on a second surface of the case other than the open surface, the first terminal being electrically connected to the electrode assembly, a second terminal disposed so as to be spaced apart from the first terminal and electrically connected to the electrode assembly, and an insulating member insulating the first terminal and the case from each other, wherein the cover is pressed in a state of being placed on the open surface of the case to be coupled to the case.

The cover may have a size larger than the open surface of the case before being coupled to the case.

The cover may be pressed in a state of being placed on the open surface of the case to be coupled to the case.

The cover may be laser-welded to the case.

The cover may be provided with a welding line extending along an inner edge of the case when the cover is coupled to the case.

After being laser-welded, the cover may be cut to a size corresponding to the size of the case.

The electrode assembly may include a first electrode plate including a first electrode tab, a second electrode plate including a second electrode tab, and a separator interposed between the first electrode plate and the second electrode plate.

The first electrode tab may be electrically connected to the first terminal, and the second electrode tab may be electrically connected to the second terminal.

The second electrode tab may be implemented as a portion of the case.

The second electrode tab may be coupled to the case.

The case may have a hexahedral shape including long side surfaces and short side surfaces. The cover may be coupled to one of the long side surfaces of the case, and the first terminal and the second terminal may be disposed on one of the short side surfaces of the case.

A method of manufacturing a secondary battery according to an embodiment of the present disclosure includes placing a case such that an open surface of the case is oriented upward, inserting an electrode assembly into the case, placing a cover on the open surface of the case, welding the cover to the case while pressing the cover, and cutting an outer peripheral portion of the cover so that the cover has a size corresponding to the size of the case.

The cover may have a size larger than the open surface of the case before being coupled to the case.

The cover may include a bent portion protruding toward the interior of the case.

The cover may be laser-welded to the case.

The cover may be provided with a welding line extending along an inner edge of the case when the cover is coupled to the case.

The electrode assembly may comprise a first electrode plate comprising a first electrode tab; a second electrode plate comprising a second electrode tab; and a separator interposed between the first electrode plate and the second electrode plate.

The first electrode tab may be electrically connected to the first terminal; and the second electrode tab may be electrically connected to the second terminal.

The second electrode tab may be implemented as a portion of the case.

The second electrode tab may be coupled to the case.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a perspective view of a secondary battery according to an embodiment of the present disclosure;

FIG. 2 is a longitudinal sectional view of the secondary battery shown in FIG. 1;

FIG. 3 is a cross-sectional view schematically showing an electrode assembly of the secondary battery shown in FIG. 1;

FIGS. 4 to 6 are schematic views showing manufacturing steps of a method of manufacturing the secondary battery shown in FIG. 1;

FIG. 7 is a cross-sectional view schematically showing the secondary battery manufactured through the manufacturing steps shown in FIGS. 4 to 6;

FIG. 8 is a schematic view showing a smartphone equipped with the secondary battery according to the embodiments of the present disclosure;

FIGS. 9 and 10 are perspective views showing a battery pack including the exemplary secondary battery according to the present disclosure;

FIG. 11 is a perspective view showing a vehicle including the exemplary battery pack according to the present disclosure; and

FIG. 12 is a side view showing a vehicle including the exemplary battery pack according to the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Additionally, in order to facilitate understanding of the invention, the attached drawings are not drawn to scale and the dimensions of some components may be exaggerated. Additionally, the same reference numbers may be assigned to the same components in different embodiments.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terms used in this specification are for describing embodiments of the present disclosure and are not intended to limit the disclosure.

Hereinafter, a secondary battery according to an embodiment of the present disclosure will be described in detail with reference to the accompanying drawings.

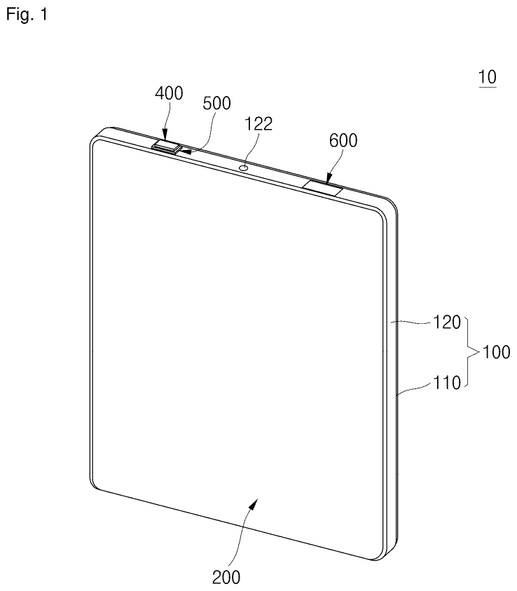

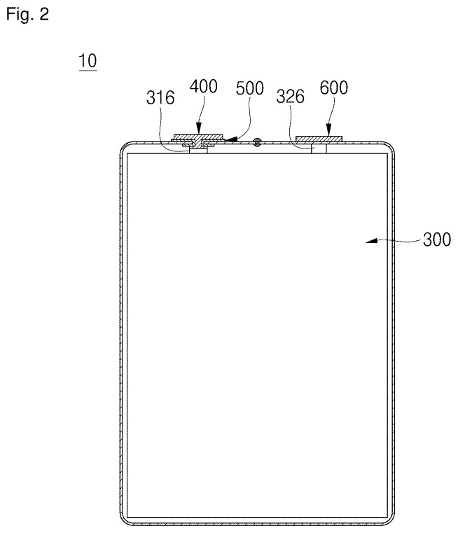

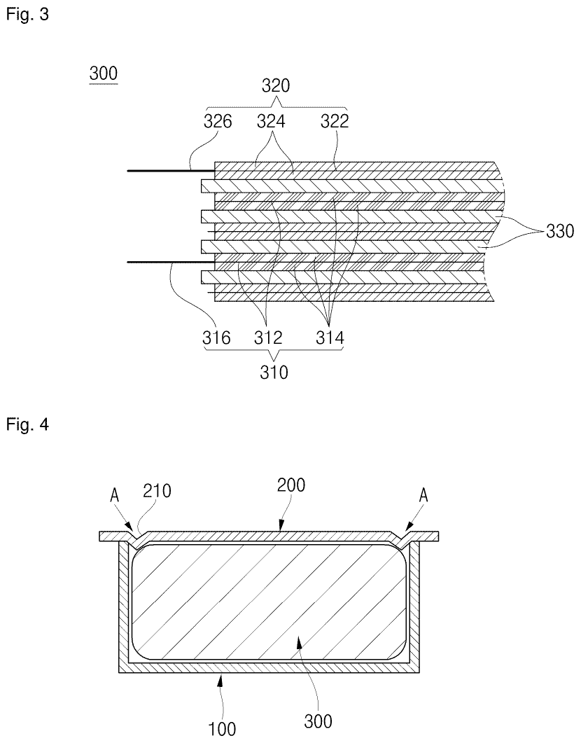

FIG. 1 is a perspective view of a secondary battery according to an embodiment of the present disclosure. FIG. 2 is a longitudinal sectional view of the secondary battery shown in FIG. 1. FIG. 3 is a cross-sectional view schematically showing an electrode assembly of the secondary battery shown in FIG. 1.

Referring to FIGS. 1 to 3, a secondary battery 10 according to an embodiment of the present disclosure may include a case 100, a cover 200, an electrode assembly 300 accommodated in the case 100, first and second terminals 400 and 600 provided on the case 100, and an insulating member 500 for insulation of the first terminal 400.

The case 100 may be formed in a cubic or rectangular parallelepiped shape having an open surface. The case 100 may include a pair of long side surfaces 110 (front and rear surfaces in FIG. 1) and four short side surfaces 120 (upper and lower surfaces and left and right surfaces in FIG. 1). The aforementioned open surface may be one of the long side surfaces 110. For example, the open surface may be the front surface in FIG. 1. The cover 200 may be coupled to the open surface of the case 100. The aforementioned first terminal 400, second terminal 600, and insulating member 500 may be provided on one of the short side surfaces 120. For example, the first terminal 400, the second terminal 600, and the insulating member 500 may be disposed on the upper surface in FIG. 1, which is one of the short side surfaces 120. An electrolyte injection hole 122 for injection of an electrolyte may be formed through the upper surface in FIG. 1, which is one of the short side surfaces 120, at a position spaced apart from the first terminal 400 and the second terminal 600. The electrolyte injection hole 122 may be shielded by a pin, a ball, or the like after injection of an electrolyte. The case 100 may include or be referred to as a can, a housing, and/or an exterior body. The case 100 may be made of steel, nickel-plated steel, a steel alloy, and/or stainless steel (SUS). The cover 200 may be coupled to the case 100 after the electrode assembly 300 is accommodated in the case 100.

The cover 200 may be a square or rectangular plate formed corresponding to the open surface of the case 100. The cover 200 may include a groove or a step 210 to achieve tight coupling to the case 100. In the drawings, the cover 200 is illustrated by way of example as including the groove 210. The groove 210 may be formed to be convex toward the interior of the case 100 so as to be inserted into the case 100 along the inner edge of the case 100. The groove 210 may be formed in various shapes. For example, the groove 210 may be formed to have a V-shaped, U-shaped, or semicircular section. Even if a stepped portion is formed instead of the groove, the disclosure is not limited to any specific shape of the stepped portion, so long as tight coupling between the cover 200 and the case 100 is achieved. The cover 200 may be made of the same material as the case 100. The cover 200 may be manufactured to be larger than the open surface of the case 100, and may then be cut after being coupled to the case 100. For example, the cover 200 may be coupled to the case 100 through laser welding. A process of coupling the cover 200 to the case 100 is described herein.

The electrode assembly 300 may be accommodated in the case 100 together with an electrolyte. The electrode assembly 300 may include or be referred to as an electrode group, an electrode body, and/or a jellyroll. The electrode assembly 300 may include a first electrode plate 310, a second electrode plate 320, and a separator 330 disposed between the first electrode plate 310 and the second electrode plate 320. The electrode assembly 300 may be configured such that the first electrode plate 310, the separator 330, and the second electrode plate 320 are stacked in a stack shape or are wound in a jellyroll shape. If the components of the electrode assembly 300 are stacked or wound, the separator 330 or the second electrode plate 320 may be disposed at the outermost periphery. The case 100 and the electrode assembly 300 may be electrically insulated from each other. For example, the first electrode plate 310 may be a positive electrode plate, and the second electrode plate 320 may be a negative electrode plate. In other embodiments, the reverse may also be possible. This embodiment will be described on the assumption that the first electrode plate 310 is a positive electrode plate.

The first electrode plate 310 may include a first substrate 312, which is a metal foil made of, for example, aluminum or an aluminum alloy, and a first active material layer 314 provided on at least one surface of the first substrate 312. The first electrode plate 310 may further include a first uncoated portion not provided with the first active material layer 314. The first uncoated portion may be provided at one end of the first substrate 312. The first uncoated portion may be notched in a predetermined shape to protrude outward from one end of the first substrate 312. This protruding portion may be referred to as a first electrode tab 316. The first electrode tab 316 may be electrically connected to the first terminal 400, which is described herein.

Because the first electrode plate 310 is a positive electrode plate, the first active material layer 314 may include a transition metal oxide. Meanwhile, as the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c (}0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-31 b-c}Mn_{b}X_{c}O_{2-31 α}D_{α} (0.90≤a≤1.8, 0≤b≤0.5, 0≤c 0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The second electrode plate 320 may include a second substrate 322, which is a metal foil made of, for example, copper, a copper alloy, nickel, or a nickel alloy, and a second active material layer 324 provided on at least one surface of the second substrate 322. The second electrode plate 320 may further include a second uncoated portion not provided with the second active material layer 324. The second uncoated portion may be provided at one end of the second substrate 322. The second uncoated portion may be notched in a predetermined shape to protrude outward from one end of the second substrate 322. This protruding portion may be referred to as a second electrode tab 326. The second electrode tab 326 may be electrically connected to the second terminal 600, which is described herein.

Because the second electrode plate 320 is a negative electrode plate, the second active material layer 324 may include graphite and/or silicon. The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator 330 may be disposed between the first electrode plate 310 and the second electrode plate 320 to prevent short circuit therebetween while allowing lithium ions to move therebetween. The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O3, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

Meanwhile, the first electrode tab 316 and the second electrode tab 326 described herein may be disposed so as to extend toward the first terminal 400 and the second terminal 600. The first electrode tab 316 and the second electrode tab 326 may be spaced apart from each other. For example, a direction in which the first electrode tab 316 and the second electrode tab 326 are disposed may be defined as the upper side of the electrode assembly 300 and the upper surface of the case 100. In other embodiments, the first uncoated portion and the second uncoated portion described above may be electrically connected to the first terminal 400 and the second terminal 600, respectively, via separate lead tabs instead of the first electrode tab 316 and the second electrode tab 326.

The first terminal 400 may be electrically connected to the first electrode tab 316 and may be insulated from the case 100 by the insulating member 500. For example, the first terminal 400 may have a hexahedral shape. The first terminal 400 may be inserted into the case 100 through a terminal hole formed in the case 100. A portion of the first terminal 400 may be located in the case 100, and the remaining portion thereof may be exposed to the outside of the case 100. The lower end of the first terminal 400 may be connected and coupled to the first electrode tab 316 through welding or the like.

The insulating member 500 may include or be referred to as a gasket or an insulator. The insulating member 500 may be made of an insulative material such as rubber or silicon. Parts of the insulating member 500, which are located outside the case 100, in the case 100, and in the terminal hole, may be formed integrally with or separately from each other.

The second terminal 600 may be coupled and electrically connected to the case 100 or may be implemented as a portion of the case 100. For example, if the second terminal 600 is provided separately, the second terminal 600 may have a hexahedral shape. The second terminal 600 may be inserted into the case 100 through a terminal hole formed in the case 100. A portion of the second terminal 600 may be located in the case 100, and the remaining portion thereof may be exposed to the outside of the case 100. The lower end of the second terminal 600 may be connected and coupled to the second electrode tab 326 through welding or the like. In other embodiments, if the second terminal 600 is implemented as a portion of the case 100, the corresponding portion of the case 100 may be coupled and electrically connected to the second electrode tab 326 through welding or the like.

As described herein, after the electrode assembly 300 is first inserted into the case 100 and then is connected to the first terminal 400 and the second terminal 600, the cover 200 may be coupled to the case 100. Thereafter, an electrolyte may be injected into the case 100 through the electrolyte injection hole 122, and then the electrolyte injection hole 122 may be shielded.

Hereinafter, a process of coupling the cover 200 to the case 100 will be described.

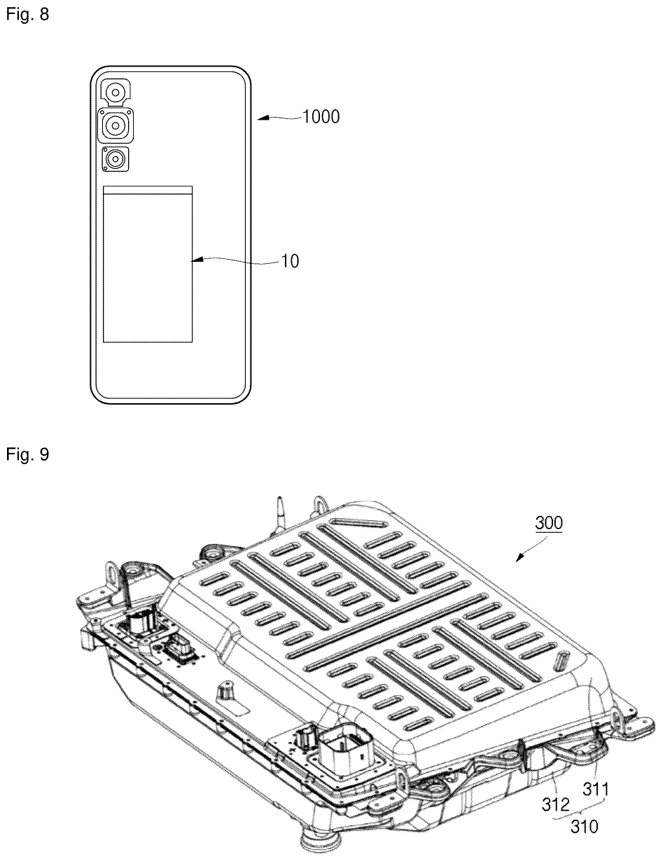

FIGS. 4 to 6 are schematic views showing manufacturing steps of a method of manufacturing the secondary battery shown in FIG. 1. FIG. 7 is a schematic cross-sectional view showing the secondary battery manufactured through the manufacturing steps shown in FIGS. 4 to 6. FIG. 8 is a schematic view showing a smartphone equipped with the secondary battery according to the embodiment of the present disclosure.

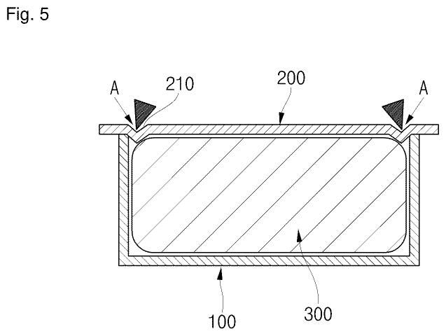

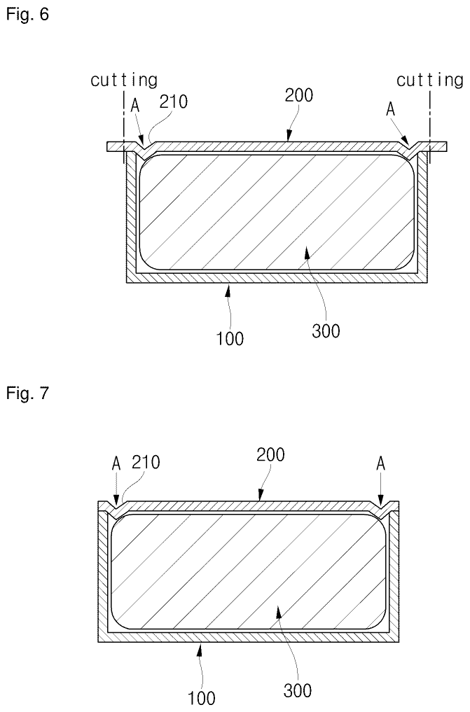

FIG. 4 shows a state in which the cover 200 is placed on the case 100. FIG. 5 shows a process of welding the cover 200 while pressing the same. FIG. 6 shows a process of cutting an extra portion of the cover 200 after the welding process.

In the manufacturing method according to the embodiment of the present disclosure, the case 100 of the secondary battery 10 may be placed such that the open long side surface thereof is oriented upward, as shown in FIG. 4. Thereafter, the electrode assembly 300 may be placed in the case 100, and the cover 200 may be placed on the open upper side of the case 100.

Thereafter, welding may be performed on the cover 200 while pressing and holding the same, as shown in FIG. 5. The cover 200 may include a bent portion 210 that is formed to be inserted into the case 100. Thus, the cover 200 and the case 100 may be maintained in a close contact state in a state in which the cover 200 is placed on the case 100 and pressed. The cover 200 may be coupled to the case 100 by welding the cover 200 while pressing and holding the same. The cover 200 may be formed to be larger than the open surface of the case 100 so that a gap is not present between the case 100 and the cover 200 when the cover 200 is coupled to the case 100. The aforementioned welding process may be laser welding. The welding process may be performed along the inner edge of the case 100. Thus, a welding line A may not cross the side surface (thickness portion) of the case 100. Because the welding line A is invisible when the cover 200 is viewed from the side surface of the case 100, a neat external appearance may be provided. However, this is merely one example. The cover 200 may be welded along the side surface of the case 100. In this case, the side surface of the case 100 and the welding line of the cover 200 may be located on the same line.

After the welding process is completed, an extra portion of the cover 200 may be cut so that the cover 200 fits the open surface of the case 100, as shown in FIG. 6. As a result, the secondary battery 10 is completely manufactured, as shown in FIG. 7.

If the case 100 is placed on the cover 200 for welding, welding may not be possible without a flange on the case 100. Thus, the size of the case 100 may be reduced due to the flange, making it impossible to increase the capacity of the secondary battery 10. In order to obviate this problem, according to the embodiment of the present disclosure, the cover 200 formed to be larger than the open surface of the case 100 may be placed on and welded to the case 100, and then an extra portion of the cover 200 may be cut so that the cover 200 fits the open surface of the case 100. Thus, the case 100 may not need to have a flange (a portion extending outside the case 100 in order to achieve welding). Further, because welding is performed along the inner edge of the case 100, welding may be possible without a flange of the case 100. Thus, the size of the case 100 may be increased due to elimination of a flange, leading to increase in the capacity of the secondary battery 10.

The secondary battery 10 according to the above-described embodiment may be used in a portable device 1000 such as a smartphone.

FIG. 8 is a schematic view showing a smartphone equipped with the secondary battery according to the embodiment of the present disclosure. As shown in FIG. 8, the secondary battery 10 according to the above-described embodiment of the present disclosure may be a small battery mounted in a small portable device such as a smartphone 1000. In this case, the case and the cover of the exemplary secondary battery 10 may have a thickness of 0.1 T (mm). According to the manufacturing method of the present disclosure, the capacity of the secondary battery 10 may be increased due to elimination of a flange, and thus the above-described secondary battery 10 may be a battery suitable for use in small portable devices.

The secondary battery according to the above-described embodiment may be increased in size and may be used to manufacture a battery pack (reference numerals of components to be described below are reference numerals that apply only to the drawings corresponding thereto).

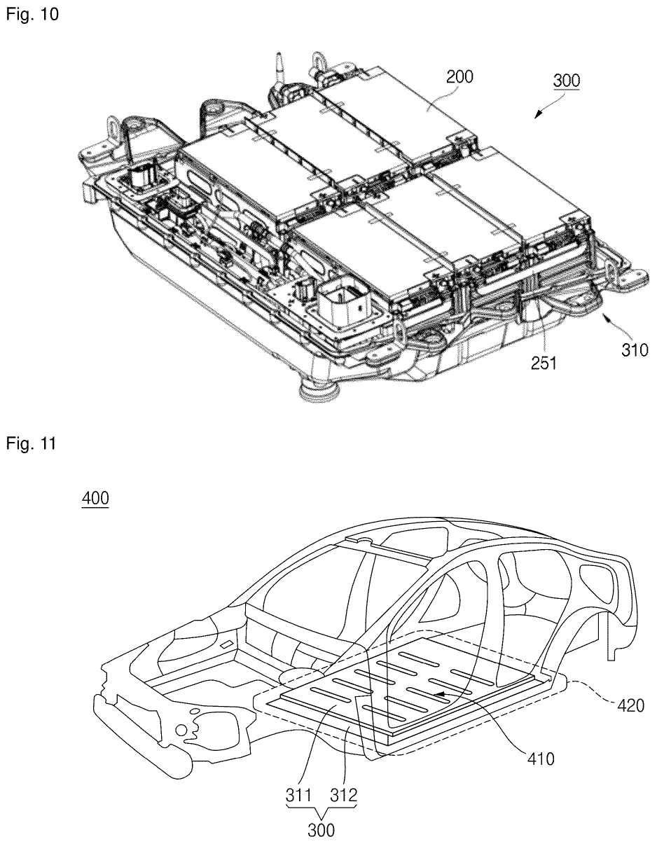

FIGS. 9 and 10 are perspective views showing a battery pack including an exemplary secondary battery 100.

Referring to FIGS. 9 and 10, the battery pack 300 may include a plurality of battery modules 200 and a housing 310 for accommodating the plurality of battery modules 200. For example, the housing 310 may include first and second housings 311 and 312 coupled in opposite directions through the plurality of battery modules 200. The plurality of battery modules 200 may be electrically connected to each other by using a bus bar 251, and the plurality of battery modules 200 may be electrically connected to each other in a series/parallel or series-parallel mixed method, thereby obtaining desired (e.g., required) electrical output. In the drawings, for convenience, components such as busbars for the electrical connection of battery cells, cooling units, and external terminals are omitted. In some examples, the battery pack (300) may be installed in a vehicle. The vehicle can be, for example, an electric vehicle, a hybrid vehicle, or a plug-in hybrid vehicle. The vehicle may include a four-wheel vehicle or a two-wheel vehicle.

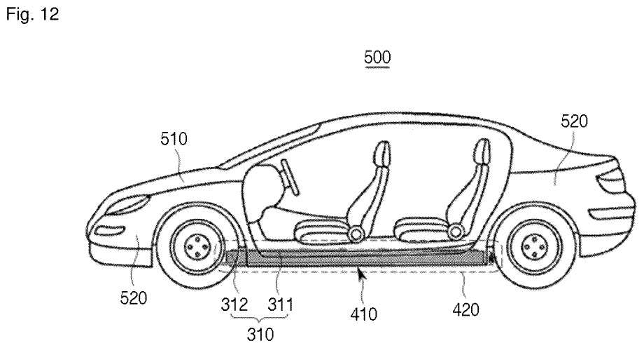

FIGS. 11 and 12 are perspective and side views of automobiles 400 and 500 including an exemplary battery pack 300 according to the present invention. In FIG. 11, a battery pack 300 may include a battery pack cover 311, which is a part of a vehicle underbody 410 and may correspond to the first housing, and a pack frame 312, which is disposed under the vehicle underbody 410 and may corresponding to the second housing. The battery pack cover 311 and the pack frame 312 may be integrally formed with a vehicle floor 420. The vehicle underbody 410 separates the inside and outside of a vehicle, and the pack frame 312 may be disposed outside the vehicle.

In FIG. 12, a vehicle 500 may be formed by combining additional parts, such as a hood 510 in front of the vehicle 500 and fenders 520 respectively located in the front and rear of the vehicle 500 to a vehicle body pars 400. The vehicle 500 may include the battery pack 300 including the battery pack cover 311 and the pack frame 312, and the battery pack 300 may be coupled to the vehicle body part 400.

As is apparent from the above description, according to the embodiment of the present disclosure, a coupling structure between a case and a cover of a small secondary battery for use in smartphones or the like may be improved, and thus the size of a dead space in the small secondary battery may be minimized.

The capacity of the secondary battery may be increased due to reduction in the size of the dead space.

However, aspects and features of the present disclosure are not limited to those described above, and other aspects and features not mentioned will be clearly understood by a person skilled in the art from the detailed description, described below.

Although a few embodiments of the present disclosure have been shown and described, it would be appreciated by those skilled in the art that various changes and modifications may be made in this embodiment without departing from the principles and spirit of the disclosure, the scope of which is defined in the appended claims and their equivalents.

What is claimed is:

1. A secondary battery comprising:
an electrode assembly;
a case accommodating the electrode assembly, the case comprising an open surface;
a plate-shaped cover coupled to the open surface of the case, the cover comprising a bent portion protruding toward an interior of the case;
a first terminal disposed on a second surface of the case other than the open surface, the first terminal being electrically connected to the electrode assembly;
a second terminal disposed so as to be spaced apart from the first terminal and electrically connected to the electrode assembly; and
an insulating member insulating the first terminal and the case from each other,
wherein the cover is pressed in a state of being placed on the open surface of the case to be coupled to the case.

2. The secondary battery as claimed in claim 1, wherein the cover has a size larger than the open surface of the case before being coupled to the case.

3. The secondary battery as claimed in claim 2, wherein the cover is welded to the case.

4. The secondary battery as claimed in claim 3, wherein the cover is laser-welded to the case.

5. The secondary battery as claimed in claim 4, wherein the cover is provided with a welding line extending along an inner edge of the case when the cover is coupled to the case.

6. The secondary battery as claimed in claim 5, wherein, after being laser-welded, the cover is cut to a size corresponding to a size of the case.

7. The secondary battery as claimed in claim 6, wherein the electrode assembly comprises:
a first electrode plate comprising a first electrode tab;
a second electrode plate comprising a second electrode tab; and
a separator interposed between the first electrode plate and the second electrode plate.

8. The secondary battery as claimed in claim 7, wherein:
the first electrode tab is electrically connected to the first terminal; and
the second electrode tab is electrically connected to the second terminal.

9. The secondary battery as claimed in claim 8, wherein the second electrode tab is implemented as a portion of the case.

10. The secondary battery as claimed in claim 8, wherein the second electrode tab is coupled to the case.

11. The secondary battery as claimed in claim 1, wherein:
the case has a hexahedral shape comprising long side surfaces and short side surfaces;
the cover is coupled to one of the long side surfaces of the case; and
the first terminal and the second terminal are disposed on one of the short side surfaces of the case.

12. A method of manufacturing a secondary battery, the method comprising:
placing a case such that an open surface of the case is oriented upward;
inserting an electrode assembly into the case;
placing a cover on the open surface of the case;
welding the cover to the case while pressing the cover; and
cutting an outer peripheral portion of the cover so that the cover has a size corresponding to a size of the case.

13. The method as claimed in claim 12, wherein the cover has a size larger than the open surface of the case before being coupled to the case.

14. The method as claimed in claim 13, wherein the cover comprises a bent portion protruding toward an interior of the case.

15. The method as claimed in claim 14, wherein the cover is laser-welded to the case.

16. The method as claimed in claim 15, wherein the cover is provided with a welding line extending along an inner edge of the case when the cover is coupled to the case.

17. The method as claimed in claim 10, wherein the electrode assembly comprises:
a first electrode plate comprising a first electrode tab;
a second electrode plate comprising a second electrode tab; and
a separator interposed between the first electrode plate and the second electrode plate.

18. The secondary battery as claimed in claim 17, wherein:
the first electrode tab is electrically connected to the first terminal; and
the second electrode tab is electrically connected to the second terminal.

19. The method as claimed in claim 18, wherein the second electrode tab is implemented as a portion of the case.

20. The method as claimed in claim 18, wherein the second electrode tab is coupled to the case.
